(19) United States
(12) Patent Application Publication
(10) Pub. No.: US 2019/0336394 A1
(43) Pub. Date: Nov. 7, 2019

(54) DUAL VIAL ADAPTER ASSEMBLAGES INCLUDING IDENTICAL TWIN VIAL ADAPTERS

(71) Applicant: West Pharma. Services IL, Ltd., Ra'anana (IL)

(72) Inventors: Igor DENENBURG, Gedera (IL); Amir LEV, Kfar Saba (IL); Uri DAVID, Nes Ziona (IL)

(21) Appl. No.: 16/303,832

(22) PCT Filed: May 10, 2017
(86) PCT No.: PCT/IL2017/050514

§ 371 Date: Nov. 21, 2018

(30) Foreign Application Priority Data
May 24, 2016 (IL) 245800

(51) Int. Cl. A61J 1/20; A61J 1/14

(52) U.S. Cl. CPC A61J 1/2096; A61J 1/2041; A61J 1/2048; A61J 1/2082; A61J 1/1406; A61J 1/2075; A61J 1/2013

(57) ABSTRACT

Dual vial adapter assemblages including two identical twin vial adapters each having an upright vial adapter connector of a first connector type and a dual ended liquid transfer coupler interdisposed between the two identical twin vial adapters and having a pair of opposite coupler ends in the form of twin connectors of a second connector type for sealed engagement with the vial adapter connectors of the first connector type.

### FIELD OF THE INVENTION

The invention relates to dual vial adapter assemblages for use with a drug vial containing a medicament and a liquid vial containing liquid contents.

### BACKGROUND OF THE INVENTION

Dual vial adapter assemblages for use with a drug vial containing a medicament and a liquid vial containing liquid contents for mixing with or reconstituting the medicament in the drug vial to form a liquid drug include one vial adapter for telescopic mounting on the liquid vial for puncturing same and another vial adapter for telescopic mounting on the drug vial for puncturing same. Dual vial adapter assemblages can be generally classified into two types as follows: A negative pressure type intended to be used with a drug vial under negative pressure for positively drawing liquid contents from a liquid vial thereinto. A gravitational flow type employing a gravitational flow of liquid contents from a liquid vial to a drug vial. The former type is generally intended for preparing a small liquid drug dosage and the latter type is generally intended for preparing a large liquid drug volume suitable for several liquid drug dosages or use with an IV set for infusion.

One exemplary negative pressure type of dual vial adapter assemblage is disclosed in commonly owned U.S. Pat. No. 6,558,365 to Zinger et al. entitled Fluid Transfer Device including two vial adapters having a highly similar resemblance but differing insofar as one vial adapter has a male connector and the other vial adapter has a female connector. The male connector is preferably a male Luer lock connector and the female connector is preferably a female Luer connector with a screw thread for screw thread attachment of a male Luer lock connector thereon. Such dual vial adapter assemblages are commercially available from West Pharmaceutical Services, Inc., Exton, USA under the registered trademark MIX2VIAL.

According to the Instructions For Use (IFU) of the Zinger dual vial adapter assemblage, the vial adapter with the male connector is intended for telescopically mounting on a liquid vial and the vial adapter with the female connector is intended for telescopically mounting on a drug vial. The use of the Zinger dual vial adapter assemblage is as follows: First, a user initially telescopically mounts the vial adapter with the male connector on a liquid vial and only thereafter telescopically mounts the vial adapter with the female connector on a drug vial otherwise negative pressure is lost in the drug vial thereby preventing positive drawing of liquid contents from a liquid vial thereinto. Second, after the positive drawing of liquid contents from the liquid vial into the drug vial, the user detaches the vial adapter with the male connector and the now empty liquid vial from the vial adapter with the female connector mounted on the drug vial now containing liquid drug contents. And finally, the user connects a needleless syringe to the vial adapter with the female connector and aspirates the liquid contents from the drug vial thereinto.

However, in the case a user inadvertently confuses between the two vial adapters, and initially telescopically mounts the vial adapter with a female connector on the liquid vial and subsequently telescopically mounts the vial adapter with the male connector on the drug vial, the drug vial still positively draws the liquid contents from the liquid vial thereinto but the liquid drug is formed in the vial adapter with the male connector and not the female connector as per the IFU. Consequently, on detachment of the vial adapter with the now empty liquid vial from the vial adapter mounted on the drug vial containing the liquid drug, the vial adapter precludes direct attachment of a needleless syringe with its male connector thereonto for aspiration purposes.

One exemplary gravitational flow type of dual vial adapter assemblage is disclosed in commonly owned U.S. Pat. No. 8,752,598 to Denenburg et al. entitled Liquid Drug Transfer Assembly. US Pat. No. '598 FIG. 9 shows a dual vial adapter assemblage including two vial adapters having a highly similar resemblance but differing insofar one vial adapter has a female connector and the other vial adapter has a dual lumen dual ended liquid transfer spike for puncturing both a liquid vial stopper and a drug vial stopper. The Denenburg dual vial adapter assemblage advantageously does not require a specific order of telescopic mounting on a liquid vial and a drug vial by virtue of gravitational flow but in a similar manner to the Zinger dual vial adapter assemblage, a user still has to correctly distinguish between the two different types of vial adapter otherwise the liquid drug can be formed in the vial adapter with the male connector precluding attachment of a needleless syringe with its male Luer lock connector.

There is a need for dual vial adapter assemblages precluding the need for a user to distinguish between two types of vial adapters with a high degree of resemblance.

### SUMMARY OF THE INVENTION

The present invention is directed towards dual vial adapter assemblages having a triple component construction as follows: First, a first vial adapter having a longitudinal first vial adapter centerline and including a transverse vial adapter top wall with an upright first vial adapter connector of a first connector type, an oppositely directed first vial adapter skirt for telescopic mounting on a drug vial, and a first vial stopper puncturing cannula for puncturing a drug vial stopper on telescopic mounting the first vial adapter on a drug vial. Second, a second vial adapter having a longitudinal second vial adapter centerline and including a transverse second vial adapter top wall with an upright second vial adapter connector of the first connector type, an oppositely directed second vial adapter skirt for telescopic mounting on a liquid vial, and a second vial stopper puncturing cannula for puncturing a liquid vial stopper on telescopic mounting the second vial adapter on a liquid vial. And third, a dual ended liquid transfer coupler interdisposed between the first vial adapter and the second vial adapter and having a pair of opposite coupler ends in the form of twin connectors of a second connector type for sealed engagement with the first vial adapter connector and the second vial adapter connector in a set-up position of the dual vial adapter assemblage such that the first vial adapter connector is in flow communication with the second vial adapter connector.

The identical twin vial adapters are preferably provided with a female Luer connector and the dual ended liquid transfer coupler is correspondingly provided with twin male Luer lock connectors. Alternatively, the identical twin vial adapters can be provided with a male Luer lock connector and the dual ended liquid transfer coupler is correspondingly provided with twin female Luer connectors.

The dual vial adapter assemblages of the present invention can be designed to be of the negative pressure type or the gravitational flow type. In the latter case, the first vial adapter and the second vial adapter are both of the vented type and each includes a dual lumen vial stopper puncturing member having a liquid lumen in flow communication with its respective vial adapter connector and a vented air lumen. The dual vial adapter assemblages of the present invention are preferably provided in a set-up position ready for immediate use on removal from suitable sterile packaging. Alternatively, the dual vial adapter assemblages may require to be assembled by a user before use.

The dual vial adapter assemblages of the present invention intended for preparing a large volume of liquid drug for infusion purposes preferably include vial adapters designed for quick release from a vial as disclosed in PCT International Publication No. WO 2012/150587 entitled Vial Adaptor. Accordingly, a vial adapter can be readily removed from a drug vial containing a liquid drug thereby exposing its drug vial stopper for insertion of an IV set for infusion of the liquid drug to a patient.

### BRIEF DESCRIPTION OF DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 is a pictorial view of an administration set including a needleless syringe, a drug vial, a liquid vial, and a dual vial adapter assemblage in accordance with a first preferred embodiment of the present invention;

FIG. 2 is an exploded view of the FIG. 1 dual vial adapter assemblage;

FIG. 3 is a longitudinal cross section of the FIG. 1 dual vial adapter assemblage along line A-A in FIG. 1;

FIG. 4A to FIG. 4D show the use of the administration set;

FIG. 5 is a longitudinal cross section of a dual vial adapter assemblage in accordance with a second preferred embodiment of the present invention;

FIG. 6 is a perspective view of a dual vial adapter assemblage in accordance with a third preferred embodiment of the present invention;

FIG. 7 is an exploded view of the FIG. 6 dual vial adapter assemblage;

FIG. 8 is a longitudinal cross section of the FIG. 6 dual vial adapter assemblage along line B-B in FIG. 6;

FIG. 9 is a longitudinal cross section of the FIG. 6 dual vial adapter assemblage along line B-B in FIG. 6 showing transfer of liquid contents from a liquid vial to a drug vial; and

FIG. 10 is a longitudinal cross section of a dual vial adapter assemblage in accordance with a fourth preferred embodiment of the present invention.

### DETAILED DESCRIPTION OF PREFERRED EMBODIMENTS OF THE INVENTION

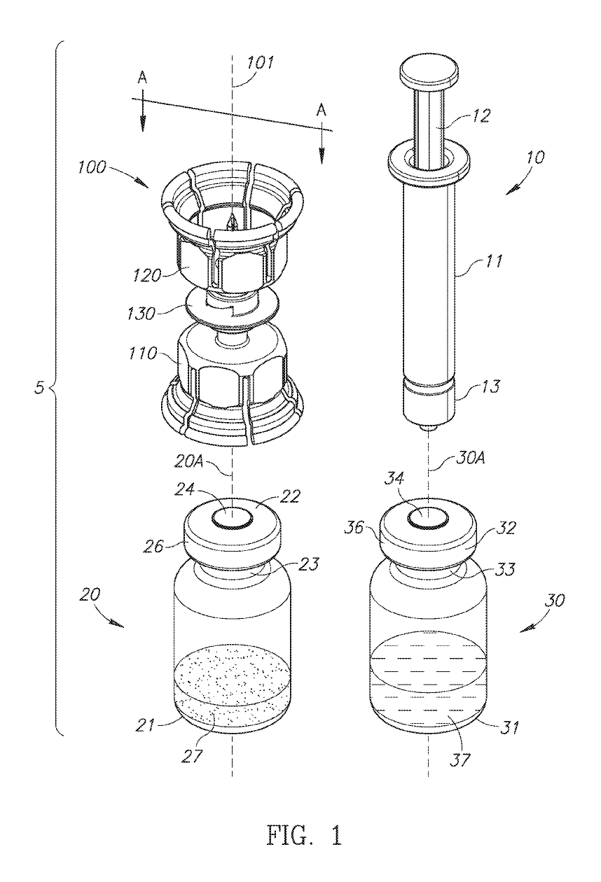

FIG. 1 shows an administration set 5 including an initially empty needleless syringe 10, a drug vial 20, a liquid vial 30 and a dual vial adapter assemblage 100 of the negative pressure type for preparing a small liquid drug dosage for aspiration into the needleless syringe 10 for administration purposes. The needleless syringe 10 includes a barrel 11 with a plunger 12 and a male Luer lock connector 13. The syringe 10 can be formed with other types of male connectors. The drug vial 20 has a longitudinal drug vial axis 20A and includes an open topped drug vial bottle 21 having a drug vial crown 22 and a narrow diameter drug vial neck 23. The drug vial crown 22 is sealed by a drug vial stopper 24. The drug vial stopper 24 is sealed by an aluminum band 26. The drug vial 20 contains a medicament 27 in the form of a powder, solid or liquid. The liquid vial 30 has a longitudinal liquid vial axis 30A and includes an open topped liquid vial bottle 31 having a liquid vial crown 32 and a narrow diameter drug vial neck 33. The liquid vial crown 32 is sealed by a liquid vial stopper 34. The liquid vial stopper 34 is sealed by an aluminum band 36. The liquid vial 30 includes liquid contents 37 in the form of diluent only or an active component.

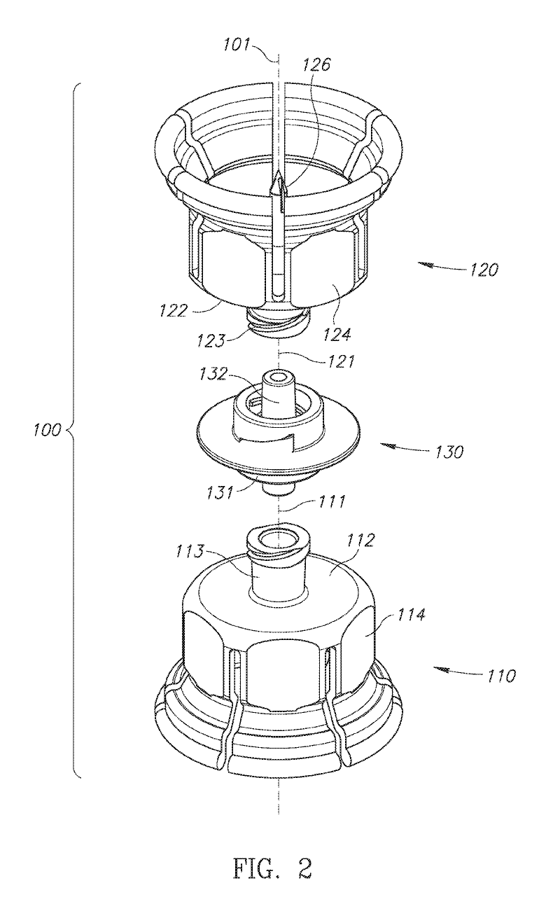

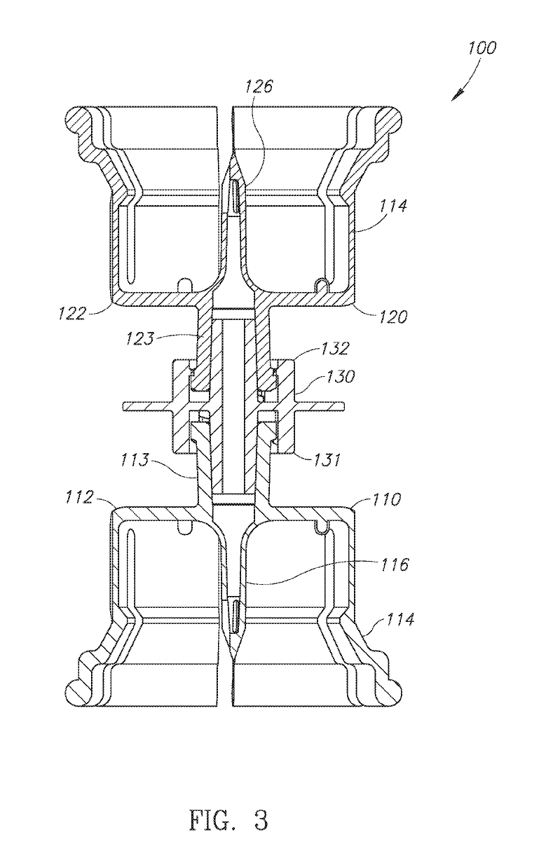

FIGS. 2 and 3 show the dual vial adapter assemblage 100 has a longitudinal dual vial adapter assemblage centerline 101 and includes a first vial adapter 110, a second vial adapter 120 and a dual ended liquid transfer coupler 130 interdisposed between the first vial adapter 110 and the second vial adapter 120 in a set-up position of the dual vial adapter assemblage 100.

The first vial adapter 110 has a longitudinal first vial adapter centerline 111 and includes a transverse first vial adapter top wall 112. The first vial adapter top wall 112 has an upright first vial adapter connector 113 of a first connector type constituted by a female Luer connector including an external screw thread for screw thread engagement by a male Luer lock connector. The first vial adapter top wall 112 has an oppositely directed first vial adapter skirt 114 for telescopic mounting on a drug vial or a liquid vial. The first vial adapter top wall 112 includes a first vial stopper puncturing cannula 116 for puncturing a vial stopper on telescopic mounting the first vial adapter 110 on a vial. The first vial stopper puncturing cannula 116 is in flow communication with the first vial adapter connector 113.

The second vial adapter 120 has a longitudinal second vial adapter centerline 121 and includes a transverse second vial adapter top wall 122. The second vial adapter top wall 122 has an upright second vial adapter connector 123 of the same connector type as the first vial adapter connector 113. The second vial adapter top wall 122 has an oppositely directed second vial adapter skirt 124 for telescopic mounting on a drug vial or a liquid vial. The second vial adapter top wall 122 includes a second vial stopper puncturing cannula 126 for puncturing a vial stopper on telescopic mounting the second vial adapter 120 on a vial. The second vial stopper puncturing cannula 126 is in flow communication with the second vial adapter connector 123.

The dual ended liquid transfer coupler 130 is formed with dual opposite connectors 131 and 132 of a second connector type for corresponding sealing engagement with the first vial adapter connector 113 and the second vial adapter connector 123 in the set-up position of the dual vial adapter assemblage 100. Accordingly, the dual opposite connectors 131 and 132 are constituted by male Luer lock connectors for corresponding sealing engagement on the female Luer connector 113 and the female Luer connector 123.

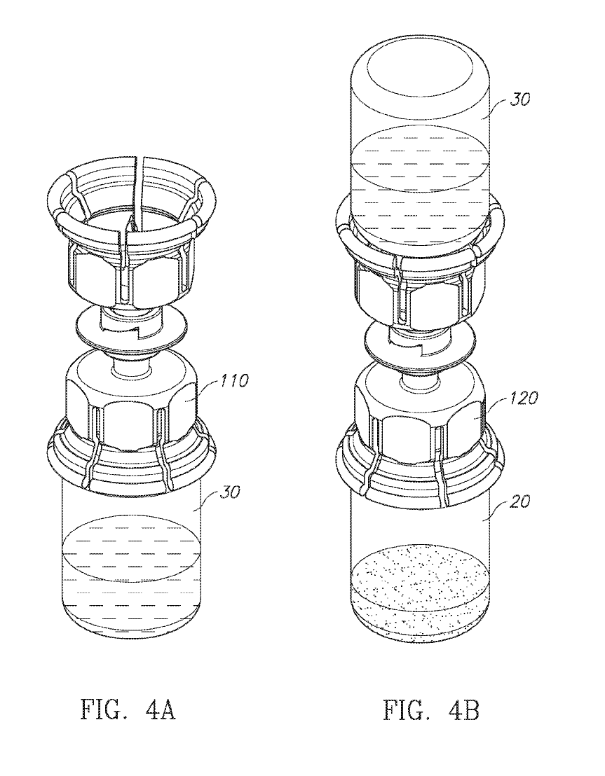

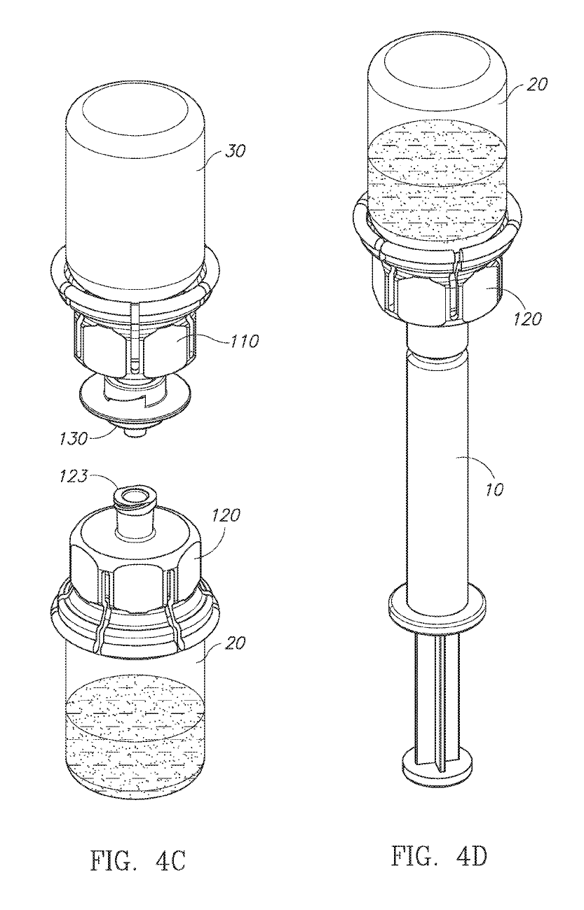

FIGS. 4A to 4D show the use of the administration set 5 for preparing a liquid drug in a drug vial 20 ready for administration to a patient as follows:

FIG. 4A shows the telescopic mounting the first vial adapter 110 on the liquid vial 30 for puncturing same. FIG. 4B shows inverting the dual vial adapter assemblage 100 together with the attached liquid vial 30 and mounting the second vial adapter 120 on the drug vial 20 for puncturing same thereby leading to positive drawing of liquid contents from the liquid vial 30 to the drug vial 20 to form a liquid drug therein. FIG. 4C shows unscrewing the dual ended liquid transfer coupler 130 from the second vial adapter 120 for exposing the female Luer connector 123. FIG. 4D shows screwing the syringe 10 onto the second vial adapter 120 for aspirating a liquid drug dosage from the drug vial 20 for administration to a patient. Alternatively, FIG. 4A to FIG. 4D could equally show telescopic mounting the second vial adapter 120 on the liquid vial 30, the first vial adapter 110 on the drug vial 20, unscrewing the dual ended liquid transfer coupler 130 from the first vial adapter 110 for exposing the female Luer connector 113 and screwing the syringe 10 onto the first vial adapter 110 for aspirating a liquid drug dosage from the drug vial 20 for administration to a patient.

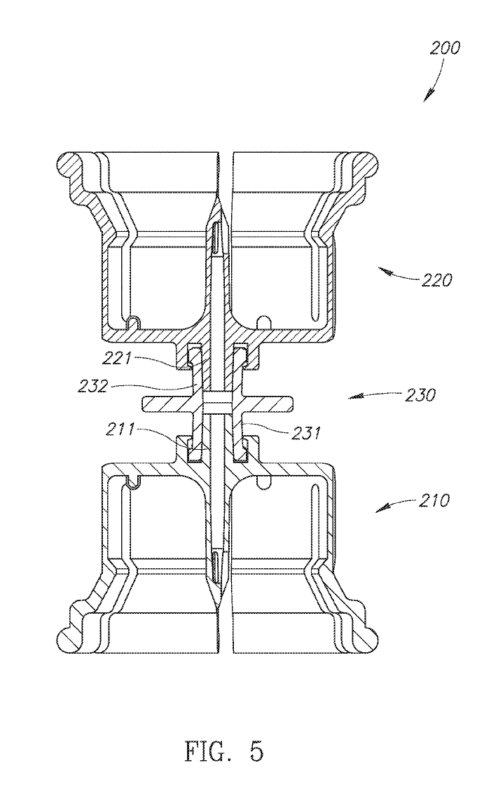

FIG. 5 shows a dual vial adapter assemblage 200 similar in construction and operation as the dual vial adapter assemblage 100. The latter 200 differs from the former 100 insofar as the latter 200 includes a first vial adapter 210 having an upright first vial adapter connector 211 of a first connector type, a second vial adapter 220 having an upright second vial adapter connector 221 of the same first connector type and a dual ended liquid transfer coupler 230 having dual opposite connectors 231 and 232 of the second connector type for corresponding sealing engagement with the first vial adapter connector 211 and the second vial adapter connector 221 in a set-up position of the dual vial adapter assemblage 200. The first connector type is constituted by a male Luer lock connector and the second connector type is constituted by a female Luer connector. The use of the dual vial adapter assemblage 200 is the same as the dual vial adapter assemblage 100 except that the dual ended liquid transfer coupler 230 is left attached to either the first vial adapter 210 or the second vial adapter 220 telescopically mounted on a drug vial 20 containing a liquid drug formed therein.

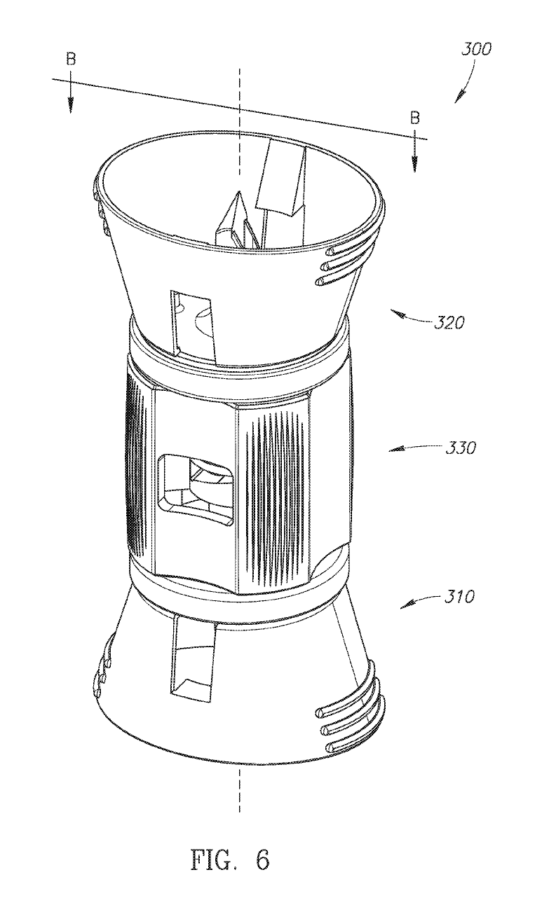

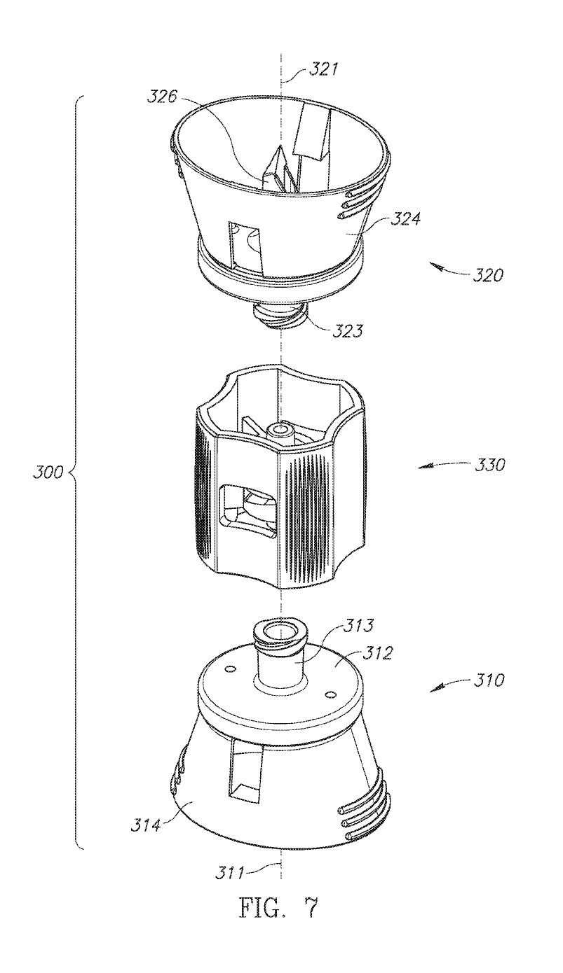

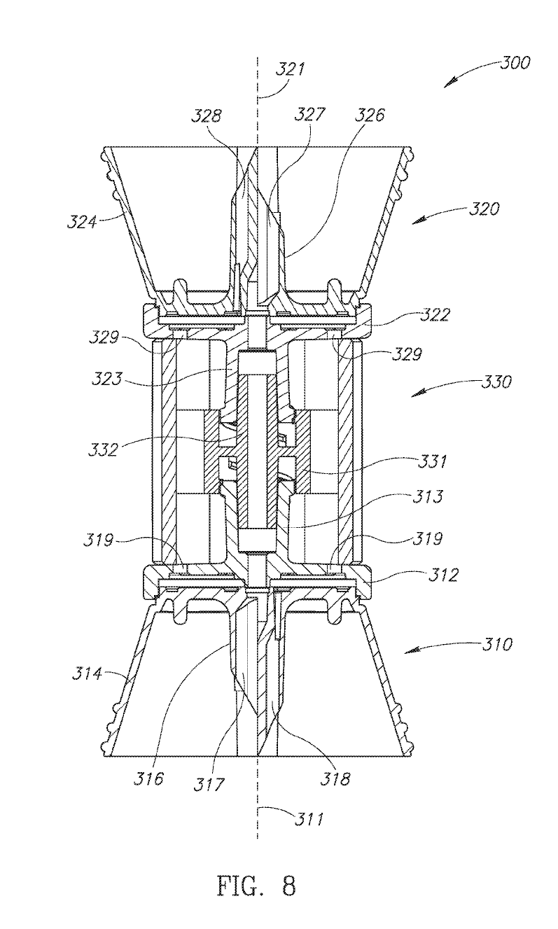

FIGS. 6 to 8 show a dual vial adapter assemblage 300 of the gravitational flow type for preparing a large liquid drug dosage. The dual vial adapter assemblage 300 includes a first vial adapter 310, a second vial adapter 320 and a dual ended liquid transfer coupler 330 intermediate the first vial adapter 310 and the second vial adapter 320. The first vial adapter 310 and the second vial adapter 320 are preferably of the quick release type as disclosed in PCT International Publication No. WO 2012/150587 entitled Vial Adaptor.

The first vial adapter 310 has a longitudinal first vial adapter centerline 311 and includes a transverse first vial adapter top wall 312 having an upright female Luer connector 313 with an external screw thread for screw thread engagement by a male Luer lock connector. The first vial adapter top wall 312 has an oppositely directed first vial adapter skirt 314 for telescopic mounting on a vial. The first vial adapter top wall 312 includes a dual lumen vial stopper puncturing cannula 316 for puncturing a vial stopper on telescopic mounting the first vial adapter 310 on a vial. The dual lumen vial stopper puncturing cannula 316 includes a liquid lumen 317 in flow communication with the female Luer connector 313 and a vented air lumen 318 with throughgoing bores 319 formed in the first vial adapter top wall 312. The liquid lumen 317 typically has a wider lumen diameter than the vented air lumen 318. The vial adapter 310 can optionally include an air filter for filtering incoming air.

The second vial adapter 320 has a longitudinal second vial adapter centerline 321 and includes a transverse second vial adapter top wall 322. The second vial adapter top wall 322 has an upright female Luer connector 323 for screw thread engagement by a male Luer lock connector. The second vial adapter top wall 322 has an oppositely directed second vial adapter skirt 324 for telescopic mounting on a vial. The second vial adapter top wall 322 includes a dual lumen vial stopper puncturing cannula 326 for puncturing a vial stopper on telescopic mounting the second vial adapter 320 on a vial. The dual lumen vial stopper puncturing cannula 326 includes a liquid lumen 327 in flow communication with the female Luer connector 323 and a vented air lumen 328 with throughgoing bores 329 formed in the second vial adapter top wall 322. The liquid lumen 327 typically has a wider lumen diameter than the vented air lumen 328. The vial adapter 320 can optionally include an air filter for filtering incoming air.

The dual ended liquid transfer coupler 330 includes dual opposite male Luer lock connectors 331 and 332 for corresponding sealing engagement with the female Luer connector 313 and the female Luer connector 323 in the set-up position of the dual vial adapter assemblage 300.

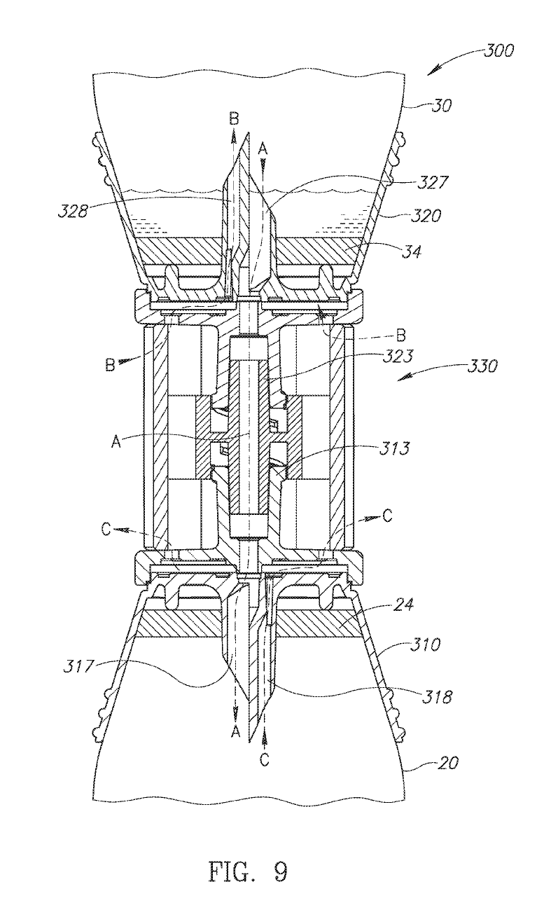

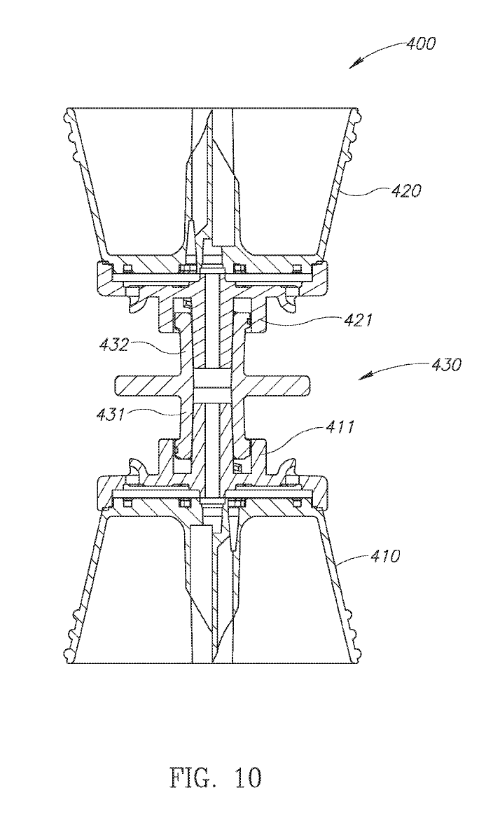

FIG. 9 shows the first vial adapter 310 telescopic mounted on the drug vial 20 and the second vial adapter 320 telescopic mounted on the liquid vial 30. Alternatively, the telescopic mounting of the dual vial adapter assemblage 300 on the drug vial 20 and the liquid vial 30 could have been reversed with the first vial adapter 310 telescopic mounted on the liquid vial 30 and the second vial adapter 320 mounted on the drug vial 20. FIG. 9 shows gravitational flow of liquid contents from the liquid vial 30 to the drug vial 20 through the liquid lumen 327, the dual ended liquid transfer coupler 330 and the liquid lumen 317 as denoted by arrows A. FIG. 9 shows the gravitational flow is facilitated by air being drawn into the liquid vial 30 via the vented air lumen 328 denoted by arrows B and air being expelled from the drug vial 20 via the vented air lumen 318 denoted by the arrows C.

The use of dual vial adapter assemblage 300 is similar to the dual vial adapter assemblage 100 except the dual ended liquid transfer coupler 330 is unscrewed from the first vial adapter 310 ready for attachment of the needleless syringe 10 for aspiration of some liquid drug from the drug vial 20. Thereafter, the second vial adapter 310 is removed from the drug vial 20 for exposing the drug vial stopper 24 for administration by an IV infusion set.

FIG. 10 shows a dual vial adapter assemblage 400 similar in construction and operation as the dual vial adapter assemblage 300. The latter 400 differs from the former 300 insofar as the latter 400 include a first vial adapter 410 having a male Luer lock connector 411, a second vial adapter 420 having a male Luer lock connector 421 and a dual ended liquid transfer coupler 430 having dual opposite female Luer connectors 431 and 432 for corresponding sealing engagement with the male Luer lock connector 411 and the male Luer lock connector 421. The use of the dual vial adapter assemblage 400 is the same as the dual vial adapter assemblage 300 except that the dual ended liquid transfer coupler 430 is left attached to either the first vial adapter 410 or the second vial adapter 420 telescopically mounted on a drug vial 20 containing a liquid drug formed therein.

While particular embodiments of the present invention are illustrated and described, it would be obvious to those skilled in the art that various other changes and modifications can be made without departing from the spirit and scope of the invention.

1. A dual vial adapter assemblage for use with a drug vial and a liquid vial, the drug vial having a drug vial bottle and a drug vial stopper sealing the drug vial bottle, the drug vial containing a medicament, the liquid vial having a liquid vial bottle and a liquid vial stopper sealing the liquid vial bottle, the liquid vial containing liquid contents for mixing with or reconstituting the medicament in the drug vial to form a liquid drug therein, the needleless syringe having a male connector, the dual vial adapter assemblage having a longitudinal dual vial adapter assemblage centerline and comprising:
(a) an integrally formed first vial adapter having a longitudinal first vial adapter centerline and including a transverse vial adapter top wall with an upright first vial adapter connector of a first connector type, an oppositely directed first vial adapter skirt for telescopic mounting on the drug vial, and a first vial stopper puncturing cannula for puncturing the drug vial stopper on said telescopic mounting said first vial adapter on the drug vial;
(b) an integrally formed second vial adapter having a longitudinal second vial adapter centerline and including a transverse second vial adapter top wall with an upright second vial adapter connector of said first connector type, an oppositely directed second vial adapter skirt for telescopic mounting on the liquid vial, and a second vial stopper puncturing cannula for puncturing the liquid vial stopper on said telescopic mounting said second vial adapter on the liquid vial; and
(c) a dual ended liquid transfer coupler having a pair of opposite coupler ends in the form of twin connectors of a second connector type for sealed engagement with said first vial adapter connector and said second vial adapter connector in a set-up position of the dual vial adapter assemblage such that said first vial adapter connector is in flow communication with said second vial adapter connector for forming the liquid drug in the drug vial,
wherein one connector type of said first connector type and said second connector type is a female connector for sealed engagement with the needleless syringe's male connector and the other connector type of said first connector type and said second connector type is a male lock connector for screw thread sealed engagement with said female connector, the arrangement being such that, in use, for aspiration of the liquid drug from the drug vial, when said first vial adapter connector is configured as a female connector, the needleless syringe is directly attachable to said first vial adapter connector, and when said first vial adapter is configured as a male connector, the needleless syringe is directly attachable to said dual ended liquid transfer coupler attached to said first vial adapter connector.

2. The assemblage according to claim 1 wherein said first vial stopper puncturing cannula includes i) a liquid lumen in flow communication with said first vial adapter connector and ii) a vented air lumen and said second vial stopper puncturing cannula includes i) a liquid lumen in flow communication with said second vial adapter connector and ii) a vented air lumen.

3. The assemblage according to claim 1 wherein said first connector type is a female Luer connector and said second connector type is a male Luer lock connector.

4. The assemblage according to claim 1 wherein said first connector type is a male Luer lock connector and said second connector type is a female Luer connector.
